(19) United States
(12) Patent Application Publication
(10) Pub. No.: US 2002/0169757 A1
(43) Pub. Date: Nov. 14, 2002

(54) Fair disclosure website for the offshore drilling industry

(76) Inventors: Mark Bouzek, Kingwood, TX (US); Janice Rudd, Houston, TX (US); Jesse Rios, Houston, TX (US)

Correspondence Address: HAYNES AND BOONE, LLP, 1000 LOUISIANA, SUITE 4300, HOUSTON, TX, 77002, US

(21) Appl. No.: 09/854,743

(22) Filed: May 14, 2001

(51) Int. Cl. G06F 17/30; G06F 7/00

(52) U.S. Cl. 707/3

(57) ABSTRACT

A third party website for providing information to users of the website regarding one or more publicly traded companies in the offshore drilling industry in compliance with Securities and Exchange Commission Regulation Fair Disclosure.

### BACKGROUND OF THE INVENTION

This invention relates generally to websites, and in particular to websites that provide information regarding publicly traded companies.

The Securities and Exchange Commission (“SEC”) recently enacted regulation Fair Disclosure (“Regulation FD”). Regulation FD punishes selective disclosure of information that is both material and non-public. Thus, publicly traded companies must now disseminate information in compliance with Regulation FD. Furthermore, the dissemination must be broad and non-exclusionary.

The present invention is directed to providing an Internet based method of complying with the requirements of Regulation FD.

### SUMMARY OF THE INVENTION

According to one embodiment of the present invention, a system for providing information regarding publicly traded companies that operate in the offshore drilling industry is provided that includes one or more users and a third party web host operably coupled to the users. The third party web host provides one or more web pages that provide information regarding the publicly traded companies that operate in the offshore drilling industry, and the third party host provides the information regarding the publicly traded companies that operate in the offshore drilling industry in compliance with the Securities and Exchange Commission Regulation Fair Disclosure.

According to another embodiment of the present invention, a method of providing information regarding publicly traded companies that operate in the offshore drilling industry is provided that includes providing a third party web site that comprises one or more web pages that permit users of the web site to obtain information regarding the publicly traded companies that operate in the offshore drilling industry. The information is provided in compliance with the Securities and Exchange Commission Regulation Fair Disclosure.

According to another embodiment of the present invention, a system for providing information regarding publicly traded companies that operate in the offshore drilling industry is provided that includes means for providing one or more web pages that permit users of the web site to obtain information regarding the publicly traded companies that operate in the offshore drilling industry on a third party website, and means for permitting users to access the third party website.

The present embodiments of the invention provide a number of advantages. For example, the system permits the publicly traded companies to comply with SEC Regulation FD in a cost-efficient manner. Furthermore, the system also provides additional information for the offshore drilling industry thereby providing the users of the system with additional value-added content. In addition, the use of a third party web host to disseminate information for the industry, and the companies active in the industry, provides for wide distribution of the information. Furthermore, the design and operation of the system provides efficient and cost effective compliance with SEC Regulation FD, provides the publicly traded companies with the freedom to speak with the investment community about important topics, provides additional exposure for the publicly traded companies to the investor community, educates investors, and provides a convenient means for monitoring the activities of competitors in the industry.

### BRIEF DESCRIPTION OF THE DRAWINGS

FIG. 1 is a schematic illustration of an embodiment of a system for providing fair disclosure of information regarding publicly traded companies in the offshore drilling industry.

FIG. 2 is a schematic illustration of an embodiment of a web home page for use in the system of FIG. 1 for providing fair disclosure of information for publicly trade companies in the offshore drilling industry.

FIGS. 3a and 3b are schematic illustrations of an embodiment of selected publicly traded company informational web page for use in the system of FIG. 1 for providing fair disclosure of information for publicly trade companies in the offshore drilling industry.

### DETAILED DESCRIPTION OF THE ILLUSTRATIVE EMBODIMENTS

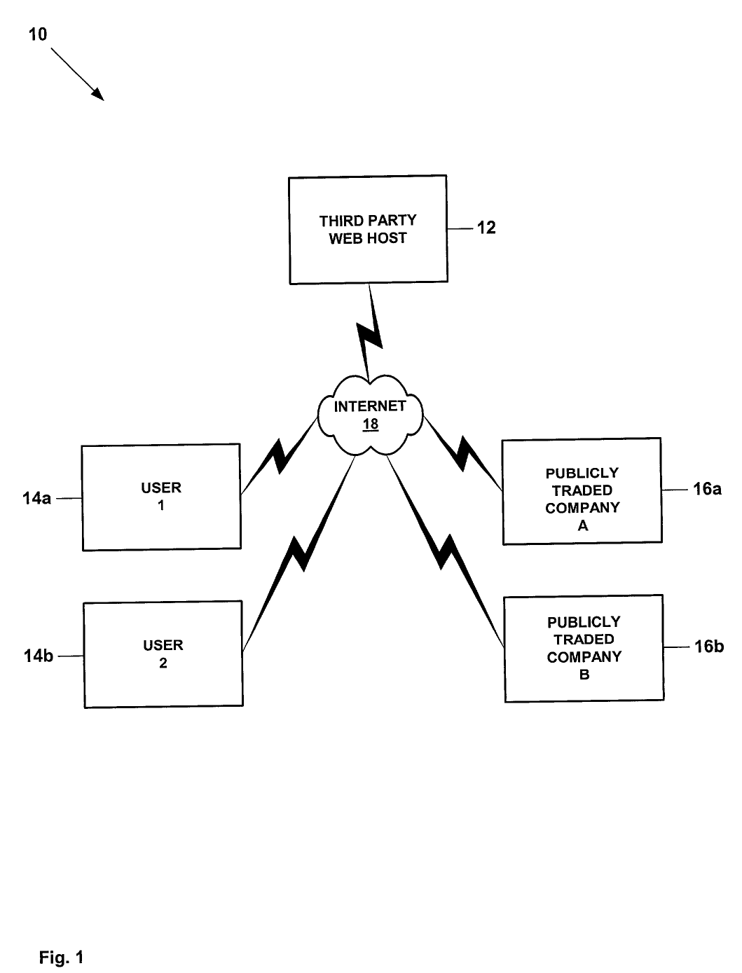

Referring initially to FIG. 1, an embodiment of a system 10 for providing fair disclosure of information regarding publicly traded companies in the offshore drilling industry includes a third party web host 12 that is operably coupled to users, 14a and 14b, and publicly trade companies, 16a and 16b, by the Internet 18. The third party web host 12 may include any number of conventional devices for hosting a web site such as, for example, servers and routers. The general theory of operation of a web site including, for example, the operation of interactive web pages that display requested information to users on another web page, is considered well known in the art. The users, 14a and 14b, may include personal computers, personal digital assistants, wireless communication device, and/or other equivalent devices, that may interact with the web host 12 via the Internet 18 in a conventional manner using, for example, a conventional Windows based Internet service provider, or equivalent system. The publicly traded companies, 16a and 16b, may include personal computers, personal digital assistants, wireless communication device, or other equivalent devices, that may interact with the web host 12 via the Internet 18 in a conventional manner using, for example, an Internet service provider. In an exemplary embodiment, the publicly traded companies operate in the offshore drilling industry. In an exemplary embodiment, the third party web host 12 is operated by an entity that is not in any manner a division, a subsidiary, a joint venture, a partner, or otherwise affiliated with the publicly traded companies, 16a and 16b.

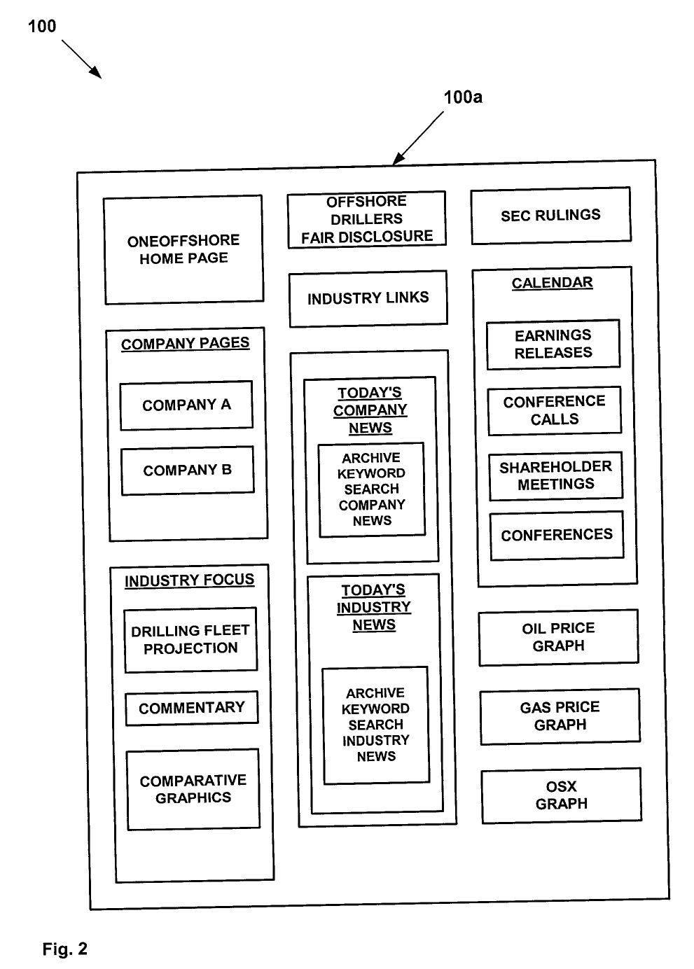

During operation of the system 10, as illustrated in FIG. 2, the web host 12 provides a web site 100 having an interactive home page 100a that is devoted to the offshore drilling industry that permits the users, 14a and 14b, to obtain information regarding the publicly traded companies, 16a and 16b, that operate in the offshore drilling industry. In an exemplary embodiment, users, 14a and 14b, of the home page 100a of the web site 100 may obtain information regarding the publicly traded companies, 16a and 16b, such as: (1) SEC rulings related to the publicly traded companies by selecting the icon SEC RULINGS; (2) a calendar of upcoming fair disclosure information releases such as, for example, earnings releases, conference calls, shareholder meetings, and other conferences, by the publicly traded companies by selecting the icon CALENDAR; (3) recent earnings releases for the publicly traded companies by selecting the icon EARNINGS RELEASES; (4) transcripts of conference calls with publicly traded companies by selecting the icon CONFERENCE CALLS; (5) transcripts of shareholder meetings for the publicly traded companies by selecting the icon SHAREHOLDER MEETINGS; (6) transcripts of press conferences for the publicly traded companies by selecting the icon CONFERENCES; (7) historical graphs of the price of oil by selecting the icon OIL PRICE GRAPHS; (8) historical graphs of the price of gas by selecting the icon GAS PRICE GRAPH; (9) historical graphs of the Oil Services Stock Index (OSX) by selecting the icon OSX; (10) links to other websites related to the offshore drilling industry such as, for example, other informational websites; (11) today's company news for the publicly traded companies by selecting the icon TODAY'S COMPANY NEWS; (12) a user defined search of all company news for the publicly traded companies contained within the company news archives of the website 100 by selecting the icon ARCHIVE KEYWORD SEARCH; (13) today's industry news for the offshore drilling industry by selecting the icon TODAY'S INDUSTRY NEWS; (14) a user defined search of all industry news for the publicly traded companies contained within the industry news archives of the website 100 by selecting the icon ARCHIVE KEYWORD SEARCH; (15) a link to the individual company web pages 100b of the publicly traded companies provided by the website 100 by selecting the corresponding icons COMPANY A or COMPANY B; (16) information regarding drilling fleet projections for the publicly traded companies by selecting the icon DRILLING FLEET PROJECTION; (17) commentary on the offshore drilling industry by selecting the icon COMMENTARY; (18) comparative graphical information regarding the publicly traded companies by selecting the icon COMPARATIVE GRAPHICS. In an exemplary embodiment, the information provided by the web home page 100a is displayed to the users 14 on another web page.

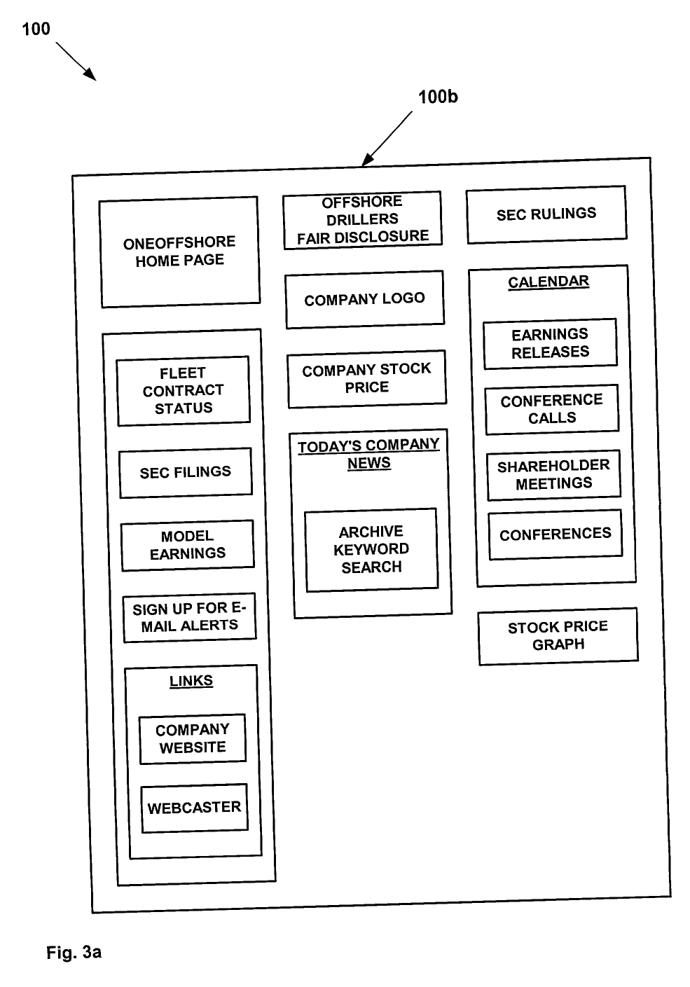

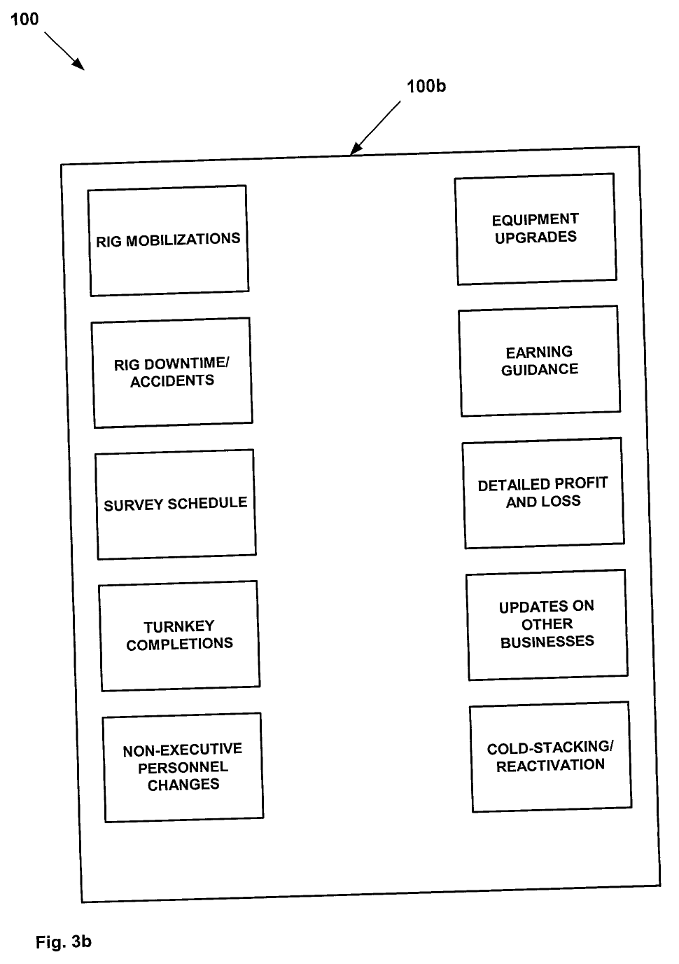

During operation of the system 10, as illustrated in FIGS. 3a and 3b, the system may further permit the users, 14a and 14b, to obtain more specific information regarding the publicly traded companies, 16a and 16b, by selecting one of the icons COMPANY A or COMPANY B on the web home page 100a to thereby access a corresponding individual company interactive web page 100b that may permit the users to obtain information regarding the one of the selected publicly traded companies that operate in the offshore drilling industry such as: (1) SEC rulings related to the selected publicly traded company by selecting the icon SEC RULINGS; (2) a calendar of upcoming fair disclosure information releases such as, for example, earnings releases, conference calls, shareholder meetings, and other conferences, for the selected publicly traded company by selecting the icon CALENDAR; (3) recent earnings releases for the selected publicly traded company by selecting the icon EARNINGS RELEASES; (4) transcripts of conference calls with the selected publicly traded company by selecting the icon CONFERENCE CALLS; (5) transcripts of shareholder meetings for the selected publicly traded company by selecting the icon SHAREHOLDER MEETINGS; (6) transcripts of press conferences for the selected publicly traded company by selecting the icon CONFERENCES; (7) a historical graph of the stock price of the selected publicly traded company by selecting the icon STOCK PRICE GRAPH; (8) a display of the selected publicly trade company's stock price; (9) today's company news for the selected publicly traded company by selecting the icon TODAY'S COMPANY NEWS; (10) a user defined search of all company news for the selected publicly traded company contained within the company news archives of the website 100 by selecting the icon ARCHIVE KEYWORD SEARCH; (11) the fleet contract status for the selected publicly traded company by selecting the icon FLEET CONTRACT STATUS; (12) SEC filings by the selected publicly traded company by selecting the icon SEC FILINGS; (13) model earnings for the selected publicly traded company by selecting the icon MODEL EARNINGS; (14) sign up for e-mail alerts regarding information regarding the selected publicly traded company; (15) access the website for the selected publicly traded company by selecting the icon COMPANY WEBSITE; (16) access a live webcast of information regarding the selected publicly traded company by selecting the icon WEBCASTER; (17) the rig mobilizations for the selected publicly traded company by selecting the icon RIG MOBILIZATIONS; (18) the rig downtime and accidents for the selected publicly traded company by selected the icon RIG DOWNTIME/ACCIDENTS; (19) the rig survey schedule for the selected publicly traded company by selected the icon SURVEY SCHEDULE; (20) the turnkey completions for the selected publicly traded company by selecting the icon TURNKEY COMPLETIONS; (21) the non-executive personnel changes at the selected publicly traded company by selecting the icon NON-EXECUTIVE PERSONNEL CHANGES; (22) equipment upgrades for the selected publicly traded company by selecting the icon EQUIPMENT UPGRADES; (23) earnings guidance for the selected publicly traded company, such as line items in the income statement, by selecting the icon EARNINGS GUIDANCE; (24) obtain detailed profit and loss information by selecting the icon DETAILED PROFIT AND LOSS; (25) obtain updates on related businesses for the selected publicly traded company, such as, for example, land rigs, and helicopter and boat utilizations, by selecting the icon UPDATES ON OTHER BUSINESSES; and (26) obtain information for cold stacking and reactivation for the selected publicly traded company by selecting the icon COLD-STACKING/REACTIVATION. In an exemplary embodiment, the information provided by the individual company web page 100b is displayed to the users 14 on another web page.

In an exemplary embodiment, all of the information provided on the website 100 that is specific to a particular one of the publicly traded companies 16 is provided on a periodic basis by the publicly traded companies to the third-party web host 12 using the Internet 18. The third party host 12 then will organize and categorize the information and make it available to the users 14 of the website 100. In an exemplary embodiment, the system 10 is operated in compliance with the requirements of Regulation FD.

The present system 10 provides a number of important benefits. For example, the system 10 permits the publicly traded companies to comply with Regulation FD in a cost-efficient manner. Furthermore, the system 10 additionally provides additional information for the offshore drilling industry thereby providing the users 14 with additional value-added content. In addition, the use of a third party web host to disseminate information for the industry, and the companies active in the industry, provides for wide distribution of the information. Furthermore, the design and operation of the system 10 provides compliance with Regulation FD, provides the publicly traded companies with the freedom to speak with the investment community about important topics, provides additional exposure for the publicly traded companies to the investor community, educates investors, and provides a convenient means for monitoring the activities of competitors in the industry.

It is understood that variations may be made in the foregoing without departing from the scope of the invention. For example, the website 100 may include a plurality of industry-specific web home pages 102a, each focused on a particular industry such as, for example, automotive, retail, or banking, and each industry specific web home page 102a may then provide links to company specific web pages for those publicly traded companies associated with the particular industry. Furthermore, the publicly traded companies 16 may provided updated information to the third party web host 12 using other means such as, for example, e-mail or snail mail.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

What is claimed is:

1. A system for providing information regarding publicly traded companies that operate in the offshore drilling industry, comprising:
one or more users;
a third party web host operably coupled to the users;
wherein the third party web host provides one or more web pages that provide information regarding the publicly traded companies that operate in the offshore drilling industry; and
wherein the third party host provides the information regarding the publicly traded companies that operate in the offshore drilling industry in compliance with the Securities and Exchange Commission Regulation Fair Disclosure.

2. The system of claim 1, wherein the third party web host provides one or more web pages that are devoted to the offshore drilling industry.

3. The system of claim 1, wherein the third party web host provides one or more web pages that are devoted to corresponding publicly traded companies that operate in the offshore drilling industry.

4. The system of claim 1, wherein the third party web host provides one or more web pages that are devoted to the offshore drilling industry; and wherein the third party web host provides one or more web pages that are devoted to corresponding publicly traded companies that operate in the offshore drilling industry.

5. The system of claim 1, further comprising:
one or more publicly traded companies that operate in the offshore drilling industry;
wherein the publicly traded companies periodically provide updated information to the third-party web host.

6. The system of claim 1, wherein the information is selected from the group consisting of:
Securities and Exchange Commission rulings related to the publicly traded companies;
a calendar of upcoming fair disclosure information releases for the publicly traded companies;
recent earnings releases for the publicly traded companies;
transcripts of conference calls with the publicly traded companies;
transcripts of shareholder meetings for the publicly traded companies;
transcripts of press conferences for the publicly traded companies;
historical graphs of the price of oil;
historical graphs of the price of gas;
historical graphs of the OSX;
company news for the publicly traded companies;
the results of a user defined search of all company news contained within the company news archives of the web host;
industry news for the offshore drilling industry;
the results of a user defined search of all industry news contained within the industry news archives of the web host;
drilling fleet projections for the publicly traded companies;
commentary on the offshore drilling industry; and
comparative graphical information regarding the publicly traded companies.

7. The system of claim 1, wherein the web host permits a user to request information for a selected one of the publicly traded companies.

8. The system of claim 7, wherein the information is selected from the group consisting of:
Securities and Exchange Commission rulings related to the selected publicly traded company;
a calendar of upcoming fair disclosure information releases for the selected publicly traded company;
recent earnings releases for the selected publicly traded company;
transcripts of conference calls with the selected publicly traded company;
transcripts of shareholder meetings for the selected publicly traded company;
transcripts of press conferences for the selected publicly traded company;
a historical graph of the stock price of the selected publicly traded company;
a display of the selected publicly trade company's stock price;
company news for the selected publicly traded company;
a user defined search of all company news for the selected publicly traded company;
the fleet contract status for the selected publicly traded company;
Securities and Exchange Commission filings by the selected publicly traded company;
model earnings for the selected publicly traded company;
the rig mobilizations for the selected publicly traded company;
the rig downtime and accidents for the selected publicly traded company;
the rig survey schedule for the selected publicly traded company;
the turnkey completions for the selected publicly traded company;
the non-executive personnel changes at the selected publicly traded company;
equipment upgrades for the selected publicly traded company;
earnings guidance for the selected publicly traded company;
detailed profit and loss information for the selected publicly traded company;
updates on related businesses for the selected publicly traded company; and
cold stacking and reactivation information for the selected publicly traded company.

9. The system of claim 1, wherein the web host permits the users to sign up for e-mail alerts that provide information regarding a selected one of the publicly traded companies.

10. The system of claim 1, wherein the web host permits the users to access the website for a selected one of the publicly traded companies.

11. The system of claim 1, wherein the web host permits the users to access a live webcast of information regarding a selected one of the publicly traded company.

12. A method of providing information regarding publicly traded companies that operate in the offshore drilling industry, comprising:
providing a third party web site that comprises one or more web pages that permit users of the web site to obtain information regarding the publicly traded companies that operate in the offshore drilling industry;
wherein the information is provided in compliance with the Securities and Exchange Commission Regulation Fair Disclosure.

13. The method of claim 12, further comprising:
the third party web site providing one or more web pages that are devoted to the offshore drilling industry.

14. The method of claim 12, further comprising:
the third party web site providing one or more web pages that are devoted to corresponding publicly traded companies that operate in the offshore drilling industry.

15. The method of claim 12, further comprising:
the third party web site providing one or more web pages that are devoted to the offshore drilling industry; and
the third party web site providing one or more web pages that are devoted to corresponding publicly traded companies that operate in the offshore drilling industry.

16. The method of claim 12, further comprising:
the publicly traded companies periodically providing updated information to the third-party web site.

17. The method of claim 12, wherein the information is selected from the group consisting of:
Securities and Exchange Commission rulings related to the publicly traded companies;
a calendar of upcoming fair disclosure information releases for the publicly traded companies;
recent earnings releases for the publicly traded companies;
transcripts of conference calls with the publicly traded companies;
transcripts of shareholder meetings for the publicly traded companies;
transcripts of press conferences for the publicly traded companies;
historical graphs of the price of oil;
historical graphs of the price of gas;
historical graphs of the OSX;
company news for the publicly traded companies;
the results of a user defined search of all company news contained within the company news archives of the web host;
industry news for the offshore drilling industry;
the results of a user defined search of all industry news contained within the industry news archives of the web host;
drilling fleet projections for the publicly traded companies;
commentary on the offshore drilling industry; and
comparative graphical information regarding the publicly traded companies.

18. The method of claim 12, further comprising:
permitting one or more of the users to request information for a selected one of the publicly traded companies from the third party web site.

19. The method of claim 18, wherein the information is selected from the group consisting of:
Securities and Exchange Commission rulings related to the selected publicly traded company;
a calendar of upcoming fair disclosure information releases for the selected publicly traded company;
recent earnings releases for the selected publicly traded company;
transcripts of conference calls with the selected publicly traded company;
transcripts of shareholder meetings for the selected publicly traded company;
transcripts of press conferences for the selected publicly traded company;
a historical graph of the stock price of the selected publicly traded company;
a display of the selected publicly trade company's stock price;
company news for the selected publicly traded company;
a user defined search of all company news for the selected publicly traded company;
the fleet contract status for the selected publicly traded company;
Securities and Exchange Commission filings by the selected publicly traded company;
model earnings for the selected publicly traded company;
the rig mobilizations for the selected publicly traded company;
the rig downtime and accidents for the selected publicly traded company;
the rig survey schedule for the selected publicly traded company;
the turnkey completions for the selected publicly traded company;
the non-executive personnel changes at the selected publicly traded company;
equipment upgrades for the selected publicly traded company;
earnings guidance for the selected publicly traded company;
detailed profit and loss information for the selected publicly traded company;
updates on related businesses for the selected publicly traded company; and
cold stacking and reactivation information for the selected publicly traded company.

20. The method of claim 12, further comprising:
permitting one or more of the users to sign up for e-mail alerts on the website that provide information regarding a selected one of the publicly traded companies.

21. The method of claim 12, further comprising:
permitting the users to access the company website for a selected one of the publicly traded companies using the website.

22. The method of claim 12, further comprising:
permitting the users to access a live webcast of information regarding a selected one of the publicly traded company using the website.

23. A system for providing information regarding publicly traded companies that operate in the offshore drilling industry, comprising:
means for providing one or more web pages that permit users of a third party web site to obtain information regarding the publicly traded companies that operate in the offshore drilling industry on a third party website in compliance with Securities and Exchange Commission Regulation Fair Disclosure; and
means for permitting users to access the third party website.

24. The system of claim 23, further comprising:
means for providing one or more web pages that are devoted to the offshore drilling industry on the third party website.

25. The system of claim 23, further comprising:
means for providing one or more web pages that are devoted to corresponding publicly traded companies that operate in the offshore drilling industry on the third party website.

26. The system of claim 23, further comprising:
means for providing one or more web pages that are devoted to the offshore drilling industry on the third party website; and
means for providing one or more web pages that are devoted to corresponding publicly traded companies that operate in the offshore drilling industry on the third party website.

27. The system of claim 23, further comprising:
means for the publicly traded companies periodically providing updated information to the third-party web host.

28. The system of claim 23, wherein the information is selected from the group consisting of:
Securities and Exchange Commission rulings related to the publicly traded companies;
a calendar of upcoming fair disclosure information releases for the publicly traded companies;
recent earnings releases for the publicly traded companies;
transcripts of conference calls with the publicly traded companies;
transcripts of shareholder meetings for the publicly traded companies;
transcripts of press conferences for the publicly traded companies;
historical graphs of the price of oil;
historical graphs of the price of gas;
historical graphs of the OSX;
company news for the publicly traded companies; p1 the results of a user defined search of all company news contained within the company news archives of the web host;
industry news for the offshore drilling industry;
the results of a user defined search of all industry news contained within the industry news archives of the web host;
drilling fleet projections for the publicly traded companies;
commentary on the offshore drilling industry; and comparative graphical information regarding the publicly traded companies.

29. The system of claim 23, further comprising:
means for permitting one or more of the users to request information for a selected one of the publicly traded companies from the third party website.

30. The system of claim 29, wherein the information is selected from the group consisting of:
Securities and Exchange Commission rulings related to the selected publicly traded company;
a calendar of upcoming fair disclosure information releases for the selected publicly traded company;
recent earnings releases for the selected publicly traded company;
transcripts of conference calls with the selected publicly traded company;
transcripts of shareholder meetings for the selected publicly traded company;
transcripts of press conferences for the selected publicly traded company;
a historical graph of the stock price of the selected publicly traded company;
a display of the selected publicly trade company's stock price;
company news for the selected publicly traded company;
a user defined search of all company news for the selected publicly traded company;
the fleet contract status for the selected publicly traded company;
Securities and Exchange Commission filings by the selected publicly traded company;
model earnings for the selected publicly traded company;
the rig mobilizations for the selected publicly traded company;
the rig downtime and accidents for the selected publicly traded company;
the rig survey schedule for the selected publicly traded company;
the turnkey completions for the selected publicly traded company;
the non-executive personnel changes at the selected publicly traded company;
equipment upgrades for the selected publicly traded company;
earnings guidance for the selected publicly traded company;
detailed profit and loss information for the selected publicly traded company;
updates on related businesses for the selected publicly traded company; and
cold stacking and reactivation information for the selected publicly traded company.

31. The system of claim 23, further comprising:
means for permitting the users to sign up for e-mail alerts that provide information regarding a selected one of the publicly traded companies using the third party web site.

32. The method of claim 23, further comprising:
means for permitting the users to access the company website for a selected one of the publicly traded companies using the third party web site.

33. The system of claim 23, further comprising:
means for permitting the users to access a live webcast of information regarding a selected one of the publicly traded company using the third party web site.

34. A system for providing information regarding publicly traded companies that operate in the offshore drilling industry, comprising:
one or more users;
one or more publicly traded companies that operate in the offshore drilling industry; and
a third party web host operably coupled to the users and the publicly traded companies;
wherein the third party web host provides one or more web pages that provide information regarding the publicly traded companies that operate in the offshore drilling industry;
wherein the third party host provides the information regarding the publicly traded companies that operate in the offshore drilling industry in compliance with the Securities and Exchange Commission Regulation Fair Disclosure;
wherein the third party web host provides one or more web pages that are devoted to the offshore drilling industry;
wherein the third party web host provides one or more web pages that are devoted to corresponding publicly traded companies that operate in the offshore drilling industry;
wherein the publicly traded companies periodically provide updated information to the third-party web host;
wherein the web host permits the users to sign up for e-mail alerts that provide information regarding a selected one of the publicly traded companies;
wherein the web host permits the users to access the website for a selected one of the publicly traded companies;
wherein the web host permits the users to access a live webcast of information regarding a selected one of the publicly traded company;
wherein the web host permits a user to request information for a selected one of the publicly traded companies; and
wherein the information is selected from the group consisting of:
Securities and Exchange Commission rulings related to the publicly traded companies;
a calendar of upcoming fair disclosure information releases for the publicly traded companies;
recent earnings releases for the publicly traded companies;
transcripts of conference calls with the publicly traded companies;
transcripts of shareholder meetings for the publicly traded companies;
transcripts of press conferences for the publicly traded companies;
historical graphs of the price of oil;
historical graphs of the price of gas;
historical graphs of the OSX;
company news for the publicly traded companies;
the results of a user defined search of all company news contained within the company news archives of the web host;
industry news for the offshore drilling industry;
the results of a user defined search of all industry news contained within the industry news archives of the web host;
drilling fleet projections for the publicly traded companies;
commentary on the offshore drilling industry;
comparative graphical information regarding the publicly traded companies;
Securities and Exchange Commission rulings related to the selected publicly traded company;
a calendar of upcoming fair disclosure information releases for the selected publicly traded company;
recent earnings releases for the selected publicly traded company;
transcripts of conference calls with the selected publicly traded company;
transcripts of shareholder meetings for the selected publicly traded company;
transcripts of press conferences for the selected publicly traded company;
a historical graph of the stock price of the selected publicly traded company;
a display of the selected publicly trade company's stock price;
company news for the selected publicly traded company;
a user defined search of all company news for the selected publicly traded company;
the fleet contract status for the selected publicly traded company;
Securities and Exchange Commission filings by the selected publicly traded company;
model earnings for the selected publicly traded company;
the rig mobilizations for the selected publicly traded company;
the rig downtime and accidents for the selected publicly traded company;
the rig survey schedule for the selected publicly traded company;
the turnkey completions for the selected publicly traded company;
the non-executive personnel changes at the selected publicly traded company;
equipment upgrades for the selected publicly traded company;
earnings guidance for the selected publicly traded company;
detailed profit and loss information for the selected publicly traded company;
updates on related businesses for the selected publicly traded company; and
cold stacking and reactivation information for the selected publicly traded company.

35. A method of providing information regarding publicly traded companies that operate in the offshore drilling industry, comprising:
providing a third party web site that comprises one or more web pages that permit users of the web site to obtain information regarding the publicly traded companies that operate in the offshore drilling industry;
the third party web site providing one or more web pages that are devoted to the offshore drilling industry;
the third party web site providing one or more web pages that are devoted to corresponding publicly traded companies that operate in the offshore drilling industry;
the publicly traded companies periodically providing updated information to the third-party web site;
permitting one or more of the users to sign up for e-mail alerts on the website that provide information regarding a selected one of the publicly traded companies;
permitting the users to access the company website for a selected one of the publicly traded companies using the website;
permitting the users to access a live webcast of information regarding a selected one of the publicly traded company using the website; and
permitting one or more of the users to request information for a selected one of the publicly traded companies from the third party web site;
wherein the information is provided in compliance with the Securities and Exchange Commission Regulation Fair Disclosure; and
wherein the information is selected from the group consisting of:
Securities and Exchange Commission rulings related to the publicly traded companies;
a calendar of upcoming fair disclosure information releases for the publicly traded companies;
recent earnings releases for the publicly traded companies;
transcripts of conference calls with the publicly traded companies;
transcripts of shareholder meetings for the publicly traded companies;
transcripts of press conferences for the publicly traded companies;
historical graphs of the price of oil;
historical graphs of the price of gas;
historical graphs of the OSX;
company news for the publicly traded companies;
the results of a user defined search of all company news contained within the company news archives of the web host;
industry news for the offshore drilling industry;
the results of a user defined search of all industry news contained within the industry news archives of the web host;
drilling fleet projections for the publicly traded companies;
commentary on the offshore drilling industry;
comparative graphical information regarding the publicly traded companies;
Securities and Exchange Commission rulings related to the selected publicly traded company;
a calendar of upcoming fair disclosure information releases for the selected publicly traded company;
recent earnings releases for the selected publicly traded company;
transcripts of conference calls with the selected publicly traded company;
transcripts of shareholder meetings for the selected publicly traded company;
transcripts of press conferences for the selected publicly traded company;
a historical graph of the stock price of the selected publicly traded company;
a display of the selected publicly trade company's stock price;
company news for the selected publicly traded company;
a user defined search of all company news for the selected publicly traded company;
the fleet contract status for the selected publicly traded company;
Securities and Exchange Commission filings by the selected publicly traded company;
model earnings for the selected publicly traded company;
the rig mobilizations for the selected publicly traded company;
the rig downtime and accidents for the selected publicly traded company;
the rig survey schedule for the selected publicly traded company;
the turnkey completions for the selected publicly traded company;
the non-executive personnel changes at the selected publicly traded company;
equipment upgrades for the selected publicly traded company;
earnings guidance for the selected publicly traded company;
detailed profit and loss information for the selected publicly traded company;
updates on related businesses for the selected publicly traded company; and
cold stacking and reactivation information for the selected publicly traded company.

36. A system for providing information regarding publicly traded companies that operate in the offshore drilling industry, comprising:
means for providing one or more web pages that permit users of a third party web site to obtain information regarding the publicly traded companies that operate in the offshore drilling industry on a third party website;
means for permitting users to access the third party website;
means for updating the information provided on the third party website;
means for providing one or more web pages that are devoted to the offshore drilling industry on the third party website;
means for providing one or more web pages that are devoted to corresponding publicly traded companies that operate in the offshore drilling industry on the third party website;
means for the publicly traded companies periodically providing updated information to the third-party web host;
means for permitting the users to sign up for e-mail alerts that provide information regarding a selected one of the publicly traded companies using the third party web site;
means for permitting the users to access the company website for a selected one of the publicly traded companies using the third party web site;
means for permitting the users to access a live webcast of information regarding a selected one of the publicly traded company using the third party web site; and
means for permitting one or more of the users to request information for a selected one of the publicly traded companies from the third party web site;
wherein the information is selected from the group consisting of:
Securities and Exchange Commission rulings related to the publicly traded companies;
a calendar of upcoming fair disclosure information releases for the publicly traded companies;
recent earnings releases for the publicly traded companies;
transcripts of conference calls with the publicly traded companies;
transcripts of shareholder meetings for the publicly traded companies;
transcripts of press conferences for the publicly traded companies;
historical graphs of the price of oil;
historical graphs of the price of gas;
historical graphs of the OSX;
company news for the publicly traded companies;
the results of a user defined search of all company news contained within the company news archives of the web host;
industry news for the offshore drilling industry;
the results of a user defined search of all industry news contained within the industry news archives of the web host;
drilling fleet projections for the publicly traded companies;
commentary on the offshore drilling industry;
comparative graphical information regarding the publicly traded companies;
Securities and Exchange Commission rulings related to the selected publicly traded company;
a calendar of upcoming fair disclosure information releases for the selected publicly traded company;
recent earnings releases for the selected publicly traded company;
transcripts of conference calls with the selected publicly traded company;
transcripts of shareholder meetings for the selected publicly traded company;
transcripts of press conferences for the selected publicly traded company;
a historical graph of the stock price of the selected publicly traded company;
a display of the selected publicly trade company's stock price;
company news for the selected publicly traded company;
a user defined search of all company news for the selected publicly traded company;
the fleet contract status for the selected publicly traded company;
Securities and Exchange Commission filings by the selected publicly traded company;
model earnings for the selected publicly traded company;
the rig mobilizations for the selected publicly traded company;
the rig downtime and accidents for the selected publicly traded company;
the rig survey schedule for the selected publicly traded company;
the turnkey completions for the selected publicly traded company;
the non-executive personnel changes at the selected publicly traded company;
equipment upgrades for the selected publicly traded company;
earnings guidance for the selected publicly traded company;
detailed profit and loss information for the selected publicly traded company;
updates on related businesses for the selected publicly traded company; and
cold stacking and reactivation information for the selected publicly traded company.
